(19) United States
(12) Patent Application Publication
(10) Pub. No.: US 2007/0233553 A1
(43) Pub. Date: Oct. 4, 2007

(54) Method of conducting an election

(76) Inventor: Francis C. Clancey, Lynnfield, MA (US)

Correspondence Address: LITMAN LAW OFFICES, LTD., P.O. BOX 15035, CRYSTAL CITY STATION, ARLINGTON, VA, 22215, US

(21) Appl. No.: 11/806,063

(22) Filed: May 29, 2007

Related U.S. Application Data
(63) Continuation-in-part of application No. 10/981,793, filed on Nov. 5, 2004.
Application No. 10/981,793 is a continuation-in-part of application No. 10/745,667, filed on Dec. 29, 2003, now abandoned.
(60) Provisional application No. 60/475,909, filed on Jun. 5, 2003.

(51) Int. Cl. G07C 13/00

(52) U.S. Cl. 705/12

(57) ABSTRACT

A method of conducting an election by voters with votes for candidates in the election is provided. This method comprises the steps of providing a computer to receive the votes from the voters for the candidates, tallying the votes for each of the candidates throughout a jurisdiction, calculating a percentage of the votes for each of the candidates by dividing the number of votes cast for each of the candidates by the number of votes cast in the jurisdiction, awarding each of the candidates a proportional percentage of votes that correspond to the percentage of the votes for each of the candidates and declaring the candidate with the most votes a winner of the election.

### CROSS-REFERENCE TO RELATED APPLICATIONS

This application is a continuation-in-part of application Ser. No. 10/981,793, filed on Nov. 5, 2004, which was filed as a continuation-in-part of application Ser. No. 10/745,667 (now abandoned), filed Dec. 29, 2003, which claimed the benefit of U.S. Provisional Patent Application Ser. No. 60/475,909, filed Jun. 5, 2003.

### BACKGROUND OF THE INVENTION

1. Field of the Invention

The present invention relates to a method of conducting an election. Particularly, the method is drawn to the provisioning of a proportion of total electoral votes to candidates based upon results of a popular vote.

2. Description of the Related Art

The principle of “one person, one vote” has long been a benchmark that is strived for, but is often not achieved in an election. For example, under our U.S. presidential electoral system, a candidate who receives the largest percentage of popular votes in a state generally receives all of that state's electoral votes. As a result, the segment of the population that voted for the less popular candidate(s) is effectively ignored. That is, since the winning candidate receives all of the electoral votes, all votes cast for the losing candidate(s) have no effect on the electoral process. This has lead to desperate struggles by presidential candidates to win the states with the most electoral votes, knowing full well that 11 such states often decide the outcome of an election. Moreover, once the “magic number” of electoral votes is achieved (i.e. 270), voting results in the remaining states become a moot point. Consequently, large numbers of votes have no effect on the outcome of an election. In addition, election results can be challenged in court when the popular vote for each candidate is too close to call, because “the winner takes all” and the loser, despite having nearly the same number of votes, gets nothing.

This principle can also pertain to elections that are held within an organization such as a stockholders' meeting or any type of election or pole. In a closely contested election, this principle can determine which participants can win or lose an election. With modern technology, such as the computer, many elections can be quickly and accurately determined, whether the election is conducted on a national scale or on a much smaller scale within a survey or research study.

None of the above inventions and patents, taken either singly or in combination, is seen to describe the instant invention as claimed. Thus a computerized system and method of conducting an election solving the aforementioned problems is desired.

### SUMMARY OF THE INVENTION

The invention is method of conducting an election by voters with votes for candidates in the election, which is preferably computerized. This method comprises the steps of providing a computer to receive the votes from the voters for the candidates, tallying the votes for each of the candidates throughout a jurisdiction, calculating a percentage of the votes for each of the candidates by dividing the number of votes cast for each of the candidates by the number of votes cast in the jurisdiction, awarding each of the candidates a proportional percentage of votes that correspond to the percentage of the votes for each of the candidates and declaring the candidate with the most votes a winner of the election.

Preferably, this voting system is made mandatory, by law or regulation, within each voting district or block. In the case of a Presidential election, this system is implemented in all 50 states of the United States of America, and in the District of Columbia.

Alternatively, once the popular vote has been tallied, the election may be reduced to the two candidates with the greatest popular votes. The remaining votes cast for the other candidates may then be discarded, and the percentage of votes recomputed with only the two candidates remaining in the computation.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an overview flow chart depicting the overall method of conducting an election.

FIG. 2 is an overview of the computerized system for conducting an election.

FIG. 3 is an illustration of an electoral map of the United States during the year 2000 U.S. presidential election.

FIG. 4 is an overview flow chart of an alternative method of conducting the election.

FIG. 5 is a table illustrating the percentages of electoral votes tabulated according to the present method.

Similar reference characters denote corresponding features consistently throughout the attached drawings.

### DETAILED DESCRIPTION OF THE PREFERRED EMBODIMENT

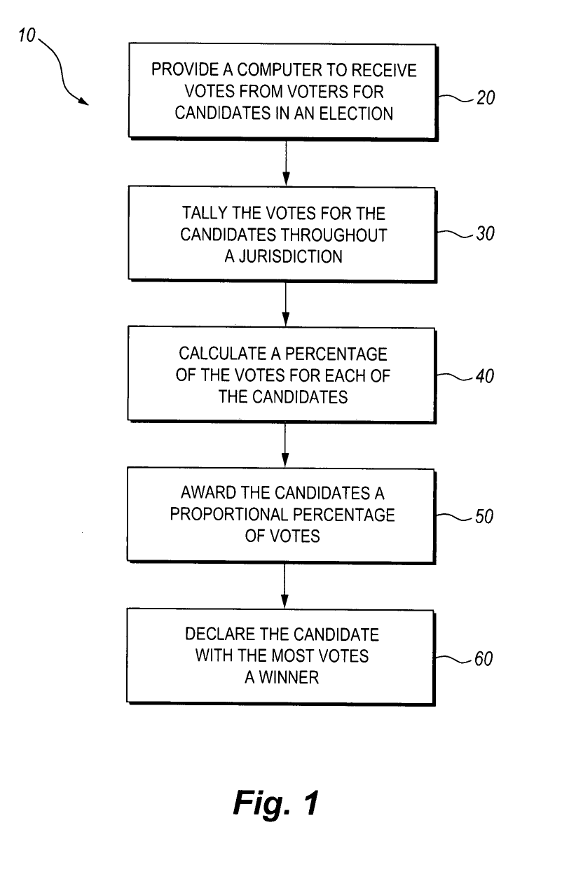

The invention is method of conducting an election by voters with votes for candidates in an election 10, comprising the steps of providing a computer to receive the votes from the voters for the candidates 20, tallying the votes for each of the candidates throughout a jurisdiction 30, calculating a percentage of the votes for each of the candidates 40 by dividing the number of votes cast for each of the candidates by the number of votes cast in the jurisdiction, awarding each of the candidates a proportional percentage of votes that correspond to the percentage of the votes for each of the candidates 50 and declaring the candidate with the most votes a winner of the election 60. These steps are outlined in FIG. 1. The method is preferably implemented in a computerized election system.

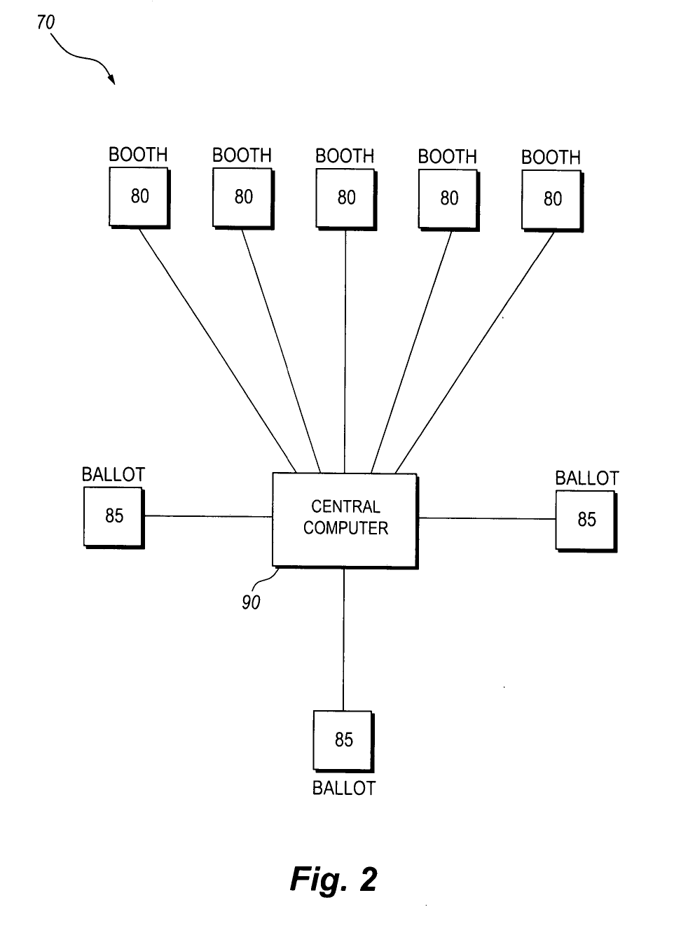

FIG. 2 illustrates an overview of a computerized system for conducting an election 70. The computerized system for conducting an election 70 comprises a plurality of voting booths 80 and a centralized computer 90 that collects and tabulates the votes from the voters in the voting booths 80. Votes can also be tabulated by gathering voting ballots and including them in the calculations done in the centralized area 90. There are several embodiments of the computerized system for conducting an election 70. Although, in the preferred embodiment, the present method is implemented in a presidential election, it should be understood that the method may bue used in any election, such as, for example, political elections, corporate elections, stockholders' elections and surveys such as marketing surveys.

Using an example, in the context of the 2000 U.S. presidential election, candidates will receive a certain percentage of the popular vote in each of the fifty states and the District of Columbia. Each candidate's percentage of the popular vote will then be converted into electoral votes by multiplying the percentage of popular vote received by the total number of electoral votes possessed by the state in question. This process is repeated for every state (and the District of Columbia).

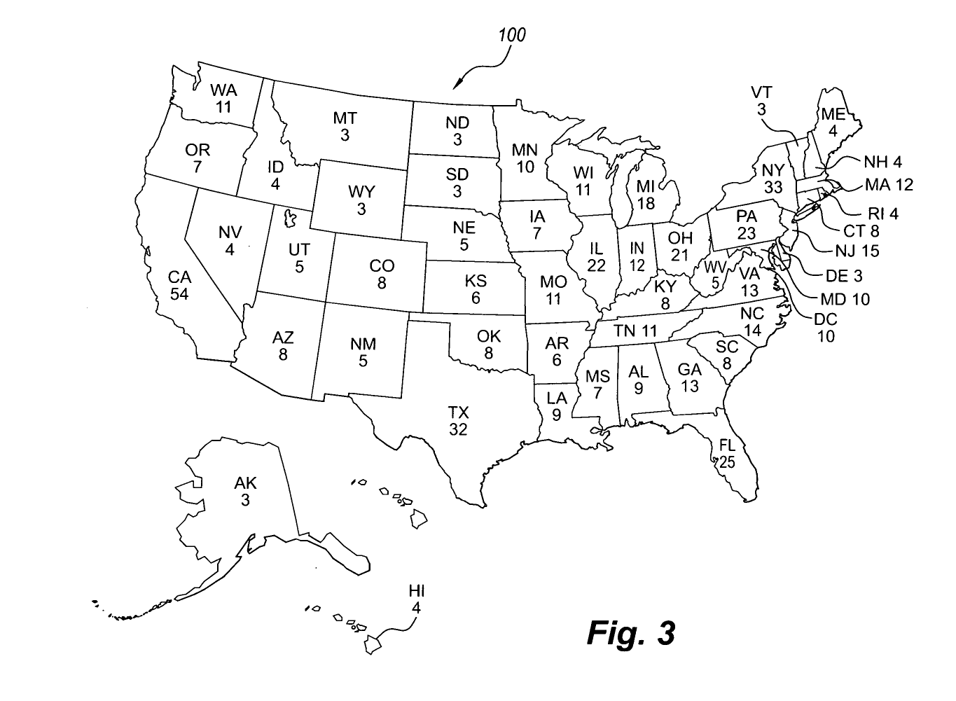

FIG. 3 illustrates an electoral map of the United States 20, which indicates the number of electoral votes possessed by each state for purposes of the 2000 U.S. Presidential Election. For example, in the last election, Vice President Gore received fifty four percent (54%) of all votes cast in the state of California. Under the method herein described, this percentage would be converted to Vice-President Gore's fair share of California's fifty-four electoral votes, which would be 29.16 electoral votes (54×0.54). Then Governor, George W. Bush, received forty-two (42%) of all votes cast. His share of electoral votes would therefore have been 22.68 electoral votes (54×0.42). Candidate Ralph Nader received four percent (4%) of the popular vote and his share of electoral votes would have been 2.16. When added together, the electoral votes apportioned to each candidate equal the total number of electoral votes assigned to the state:

| | |
|---|---|
| A. Gore | 29.16 |
| G. Bush | 22.68 |
| R. Nader | 2.16 |
| Total | 54.00 |

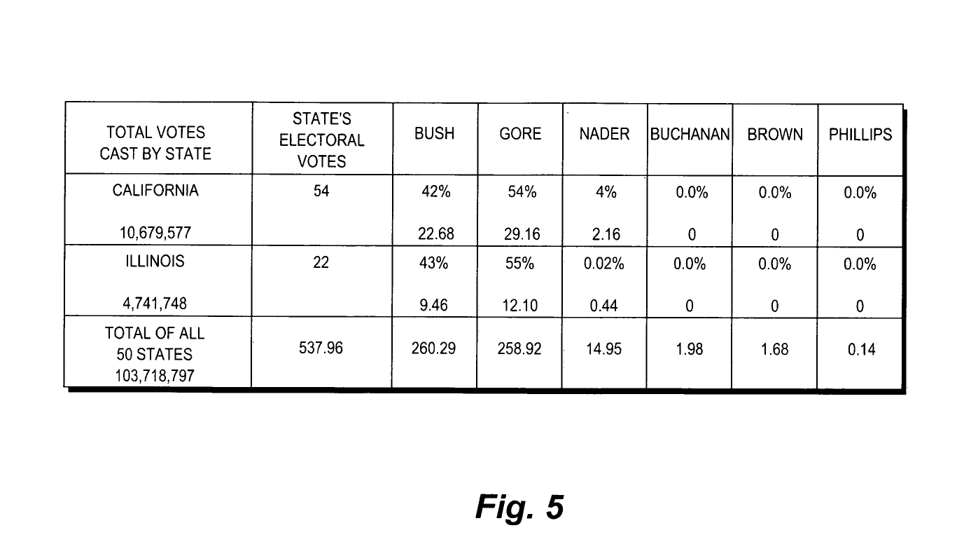

The four remaining candidates, (Buchanan, Browne, Phillips and Hagelin) failed to win enough votes to qualify for a percentage of California's electoral votes. Had this method been implemented in the last presidential election, the results could be represented as shown in the table of FIG. 5. Please note that voting statistics from the remaining 48 states and the District of Columbia (added to the previous two states, namely, California and Illinois) are shown in the last line of the table of FIG. 5.

Had a proportional allocation of electoral votes system been in place during this election, it must be noted in the table of FIG. 5 that there is no constitutional winner in this election, since the 270 electoral votes, as mandated by the U.S. Constitution, had not been awarded any of the candidates by the electors (voters). The more candidates entering an election, the greater the possibility of dilution of the popular votes awarded a candidate cast by the electors (voters). This further affects the number of electoral votes a candidate may receive.

There is a discrepancy of 0.04% due to voters in the state of Nevada casting a total of 608,899 votes, of which 3,315 voters did not vote for any of the seven candidates. Note that this is 0.01% or 0.04 of the total ballots cast and that the state of Nevada has an award of 4 electoral votes.

In this way, every vote cast contributes to the selected candidate's total electoral votes. This method stands in stark contrast to the present method in which millions of votes have no effect on electoral votes (e.g. in California, the 4,437,557 votes for Bush produced no electoral votes for him).

Furthermore, no constitutional amendment would be necessary in order to implement this system and method. There is no constitutional requirement that all of a state's electoral votes be awarded to the candidate with the greatest share of the popular vote. In fact, two states (Maine and Nebraska) award only two electoral votes to the winning candidate, with the rest of the electoral votes distributed according to the winner of each congressional district in the state. The Constitution requires only that each state appoint a number of electors equaling the total number of congressmen (senators and representatives) from that state, and that such electors vote for the President and the Vice-President. Accordingly, the states can decide for themselves whether to implement the method herein discussed.

Preferably, in the above method, the method is implemented in all voting jurisdictions. In the United States Presidential Election, the method is implemented in all 50 states and in the District of Columbia. As noted above, Maine and Nebraska presently utilize a separate voting method from the other 48 states. Under the preferred embodiment, all states, including Maine and Nebraska, would implement the method. Preferably, this implementation is mandatory, via a constitutional amendment, federal law or the like. It should be understood that this method may be applied to other electoral systems (such as a stockholder's election within a corporation, for example), and the method is preferably implemented within all groupings, regions, districts and sections of an electing body.

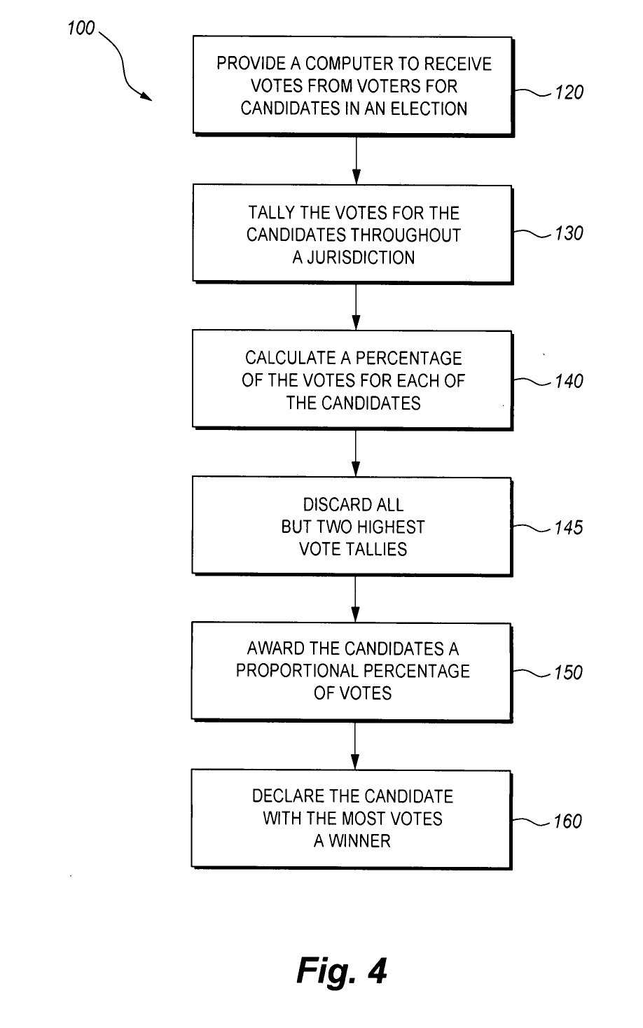

Alternatively, the method 10 may be modified, as shown in FIG. 4. In method 100 of FIG. 4, steps 120, 130, 140, 150 and 160 are substantially similar to the corresponding steps 20, 30, 40, 50 and 60 of method 10 of FIG. 1. However, an intermediate step 145 has been inserted. At step 145, only the two candidates with the highest number of popular votes are considered and the rest are discarded.

In the above example of the 2000 Presidential election, Gore received 54% of the popular votes cast in the state of California and Bush received 42% of the votes cast in the state of California. Rather than computing the proportional number of electoral votes for all candidates (including Nader, Buchanan, etc.), only Bush and Gore are considered. At step 145 of method 100, the remaining candidates are discarded, and the number of popular votes associated with the discarded candidates are also discarded.

In the above example, the total number of votes in California was 10,679,577. Bush received 42% of these votes (approximately 4,437,557 popular votes), Gore received 54% of these votes (approximately 5,721,195 popular votes) and Nader received approximately 4% of these votes (approximately 405,722). The remaining candidates in the election received statistically negligible numbers of popular votes: Browne received 44,292 popular votes, Buchanan received 43,751 popular votes, Phillips received 16,484 popular votes, and Hagelin received 10,576 popular votes.

In step 145 of FIG. 4, the votes for all of the candidates other than Bush and Gore are discarded. Thus, the total number of popular votes is lowered to 10,158,752. Bush then receives 4,437,557/10,158,752 (approximately 43.7% of the votes), and Gore receives approximately 56.3% of the votes, thus providing a much clearer margin for determining electoral votes (based on the popular vote). Bush is then granted 43.7% of the total electoral votes, and Gore is granted 56.3% of the total electoral votes (with both electoral votes being based upon the percentage from the re-calculated popular vote).

The discarded popular votes and their percentages are subtracted from a state's (and from the District of Columbia) total popular votes cast by the electors (voters) of a jurisdiction. The resulting number of popular votes are then divided between the two (2) candidates that received the most popular votes subjected to the same percentages they received by each state and the District of Columbia during the general election and re-allocated as shown above, which encompasses the results of the state of California.

Thus, Gore's total increases to 56% and Bush's total increases to 44%; a 2% increase for both candidates. This same procedure is used in all 50 states and the District of Columbia's tallies.

It is to be understood that the present invention is not limited to the embodiments described above, but encompasses any and all embodiments within the scope of the following claims.

I claim:

1. A computerized method of conducting an election by voters with votes for candidates in the election, comprising the steps of:
providing a computer to receive popular votes from the voters for the candidates;
tallying the popular votes for each of the candidates throughout a jurisdiction;
calculating a percentage of the popular votes for each of the candidates by dividing the number of popular votes cast for each of the candidates by the total number of popular votes cast in the jurisdiction;
establishing a set of electoral votes for each jurisdiction;
calculating a proportional percentage of electoral votes corresponding to the percentage of the popular votes for each of the candidates;
awarding each of the candidates the proportional percentage of electoral votes corresponding to the percentage of the popular votes for each of the candidates; and
declaring the candidate with the most electoral votes a winner of the election, wherein said computerized method of conducting an election is conducted in all jurisdictions of a voting body.

2. The computerized method of conducting an election by voters with votes for candidates in the election according to claim 1, wherein the election is a political election.

3. The computerized method of conducting an election by voters with votes for candidates in the election according to claim 1, wherein the election is a corporate election.

4. The computerized method of conducting an election by voters with votes for candidates in the election according to claim 1, wherein the election is a stockholders' election.

5. The computerized method of conducting an election by voters with votes for candidates in the election according to claim 1, wherein the election is a survey.

6. The computerized method of conducting an election by voters with votes for candidates in the election according to claim 1, further comprising the steps of:
following said step of calculating a percentage of the popular votes, determining two candidates with the highest number of popular votes;
discarding the popular votes given to the candidates other than said two candidates with the highest number of popular votes;
recalculating the total number of popular votes; and,
recalculating the percentage of popular votes for the remaining two candidates based upon the recalculated total number of popular votes.

7. A computerized method of conducting an election by voters with votes for candidates in the election, comprising the steps of:
providing a computer to receive popular votes from the voters for the candidates;
tallying the popular votes for each of the candidates throughout a jurisdiction;
calculating a percentage of the popular votes for each of the candidates by dividing the number of popular votes cast for each of the candidates by the total number of popular votes cast in the jurisdiction;
determining two candidates with the highest number of popular votes;
discarding the popular votes given to the candidates other than said two candidates with the highest number of popular votes;
recalculating the total number of popular votes;
recalculating the percentage of popular votes for the remaining two candidates based upon the recalculated total number of popular votes;
establishing a set of electoral votes for each jurisdiction;
calculating a proportional percentage of electoral votes corresponding to the percentage of the recalculated popular votes for each of the two remaining candidates;
awarding each of the two candidates the proportional percentage of electoral votes corresponding to the percentage of the popular votes for each of the candidates; and,
declaring the candidate with the most electoral votes a winner of the election.

8. The computerized method of conducting an election by voters with votes for candidates in the election according to claim 7, wherein the election is a political election.

9. The computerized method of conducting an election by voters with votes for candidates in the election according to claim 7, wherein the election is a corporate election.

10. The computerized method of conducting an election by voters with votes for candidates in the election according to claim 7, wherein the election is a stockholders' election.

11. The computerized method of conducting an election by voters with votes for candidates in the election according to claim 7, wherein the election is a survey.

12. The computerized method of conducting an election by voters with votes for candidates in the election according to claim 7, wherein said computerized method of conducting an election is implemented within all jurisdictions of a voting body.

13. The computerized method of conducting an election by voters with votes for candidates in the election according to claim 11, wherein the election is a marketing survey.
